(19) United States
(12) Patent Application Publication
(10) Pub. No.: US 2021/0091355 A1
(43) Pub. Date: Mar. 25, 2021

(54) HEAT RESISTANT FIBER LAYER FOR BATTERY INSULATION

(71) Applicants: Mitsubishi Chemical America, Inc., New York, NY (US); Mitsubishi Chemical Advanced Materials, Inc., Commerce Township, MI (US)

(72) Inventors: Vineet KAPILA, Commerce Township, MI (US); Joseph GEORGE, West Bloomfield, MI (US)

(73) Assignees: Mitsubishi Chemical America, Inc., New York, NY (US); Mitsubishi Chemical Advanced Materials, Inc., Commerce Township, MI (US)

(21) Appl. No.: 17/025,551

(22) Filed: Sep. 18, 2020

Related U.S. Application Data
(60) Provisional application No. 62/904,411, filed on Sep. 23, 2019.

(51) Int. Cl. H01M 2/10

(52) U.S. Cl. CPC H01M 2/1094; H01M 2/1072

(57) ABSTRACT

A heat resistant structure for enclosing a battery is presented. The structure includes a heat resistant fiber layer that provides insulation and structural resistance against a battery failure leading to high temperatures, for instance, in a thermal runaway event. The heat resistant fiber layer may comprise a polycrystalline aluminosilicate fiber.

### CROSS REFERENCE TO RELATED APPLICATIONS

This application claims the benefit of priority from U.S. Provisional Application No. 62/904,411 filed Sep. 23, 2019, which is incorporated herein by reference in its entirety.

### BACKGROUND OF THE INVENTION

### Technical Field

The present invention relates to a heat resistant structure for enclosing a battery.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

There is currently a trend in the automotive industry to replace combustion engines with electric motors or a combination of an electric motor and a combustion engine, thereby substantially reducing the environmental impact of automobiles by reducing (i.e., hybrids) or completely eliminating (i.e., electric vehicles) car emissions. This switch in drive train technology is not, however, without its technological hurdles as the use of an electric motor translates to the need for rechargeable batteries with high energy densities, long operating lifetimes, and operable in a wide range of conditions. Additionally, it is imperative that the battery pack of a vehicle pose no undue health threats, either during vehicle use, storage, or in the event of accidents and mechanical failure.

While current rechargeable battery technology is able to meet the demands of the automotive industry, the relatively unstable nature of the compounds used in such batteries often leads to specialized handling and operating requirements. For example, rechargeable batteries such as lithium-ion cells tend to be more prone to thermal runaway than primary cells, thermal runaway occurring when the internal reaction rate increases to the point that more heat is being generated than can be withdrawn, leading to a further increase in both reaction rate and heat generation. Eventually the amount of generated heat is great enough to lead to the combustion of the battery as well as materials in proximity to the battery. Thermal runaway may be initiated by a short circuit within the cell, improper cell use, physical abuse, manufacturing defects, or exposure of the cell to extreme external temperatures. In the case of a battery pack used in an electric vehicle, a severe car crash may simultaneously send multiple cells within the battery pack into thermal runaway.

During a thermal runaway event, a large amount of thermal energy is rapidly released, heating the entire cell up to a temperature of 850° C. or more. Due to the increased temperature of the cell undergoing thermal runaway, the temperature of adjacent cells within the battery pack will also increase. If the temperature of these adjacent cells is allowed to increase unimpeded, they may also enter into a state of thermal runaway, leading to a cascading effect where the initiation of thermal runaway within a single cell propagates throughout the entire battery pack. As a result, power from the battery pack is interrupted and the system employing the battery pack is more likely to incur extensive collateral damage due to the scale of thermal runaway and the associated release of thermal energy.

While a number of approaches have been adopted to try to lower the risk of thermal runaway as well as its propagation throughout the battery pack, it is also critical that if a pack-level thermal runaway event does occur, personal and property risks are minimized. With this view, fire resistant enclosures have been used to as a barrier against the spread of battery fire while also providing structural support in thermal runaway conditions, thus protecting the battery while minimizing any resulting damage. However, these enclosures typically comprise metal panels, for instance, steel or aluminum, and the substantial weight of these panels reduces the efficiency of the electric vehicle.

Accordingly, what is needed is a heat resistant structure to provide support and insulation to a battery cell. Such heat resistant structure must be able to withstand heat produced by battery fire or thermal runaway and yet must also be a lightweight material. In view of the foregoing, one objective of the present disclosure is to provide a heat resistant structure for a battery, where the heat resistant structure comprises a heat resistant fiber layer.

### BRIEF SUMMARY OF THE INVENTION

According to a first aspect, the present disclosure relates to a heat resistant structure for a battery. The heat resistant structure comprises an enclosure top and an enclosure bottom configured to enclose a battery. The enclosure top is attached to and in direct contact with the enclosure bottom. The enclosure top and the enclosure bottom comprise a structural composite material. The heat resistant structure also comprises a heat resistant fiber layer positioned above the enclosure top, and this heat resistant fiber layer comprises a heat resistant fiber.

In one embodiment, the heat resistant structure further comprises a support layer top located above the heat resistant fiber layer.

In one embodiment, the heat resistant fiber layer is sandwiched between a support layer top and a support layer bottom.

In a further embodiment, the heat resistant fiber layer is encapsulated between the support layer top and the support layer bottom.

In one embodiment, the heat resistant fiber layer encircles a top and sides of the battery enclosure top and a bottom and sides of the battery enclosure bottom.

In one embodiment, the heat resistant fiber comprises a ceramic fiber, a polycrystalline alumina fiber, or a glass fiber.

In one embodiment, the heat resistant fiber comprises 65-80 wt % alumina and 20-35 wt % silica, each relative to a total weight of the heat resistant fiber.

In one embodiment, the heat resistant fiber layer consists essentially of the heat resistant fiber.

In one embodiment, the heat resistant fiber has an average fiber diameter in a range of 4.5-8.5 μm.

In one embodiment, the heat resistant fiber layer has an average thickness in a range of 0.2-4 cm.

In one embodiment, the enclosure top and the enclosure bottom each independently comprise a polymeric material or a fiber composite material.

In one embodiment, the enclosure top and the enclosure bottom each independently comprise glass mat thermoplastic, polypropylene, polyimide, carbon fiber, thermoset material.

In one embodiment, the heat resistant fiber is woven together by a twill dutch weave, a hex weave, a plain weave, a twill weave, or a basketweave.

In one embodiment, the heat resistant structure further comprises a support layer bottom located between the heat resistant fiber layer and the enclosure top.

In one embodiment, the heat resistant structure is heat resistant to a temperature greater than 800° C.

In one embodiment, the heat resistant fiber layer is heat resistant to a temperature in a range of 1,400-1,700° C.

In one embodiment, the heat resistant structure further comprises a fire-resistant adhesive.

In one embodiment, the enclosure top or the enclosure bottom comprises a vent valve.

According to a second aspect, the present disclosure relates to a heat resistant structure for a battery. The heat resistant structure comprises an enclosure top and an enclosure bottom configured to enclose a battery. The enclosure top attached to and in direct contact with the enclosure bottom. The heat resistant structure also comprises a heat resistant fiber layer positioned between and enclosed by the enclosure top and the enclosure bottom.

In one embodiment, the heat resistant structure further comprises a support layer bottom underneath and in direct contact with the heat resistant layer. The support layer bottom is configured to be positioned above the battery.

In one embodiment, the heat resistant structure further comprises a support layer top positioned between the enclosure top and the heat resistant layer.

In one embodiment, the heat resistant layer is encapsulated within the support layer top and the support layer bottom.

In one embodiment, the heat resistant layer encircles the top, bottom, and sides of the battery.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows an embodiment of the heat resistant structure with the heat resistant fiber layer located outside of the battery enclosure.

FIG. 2 shows another embodiment of the heat resistant structure with the heat resistant fiber layer located outside of the battery enclosure.

FIG. 3 shows another embodiment of the heat resistant structure with the heat resistant fiber layer located outside of the battery enclosure, and sandwiched between two support layers.

FIG. 4 shows an embodiment of the heat resistant structure with the heat resistant fiber layer located inside the battery enclosure.

FIG. 5 shows another embodiment of the heat resistant structure with the heat resistant fiber layer located inside the battery enclosure, and sandwiched between two support layers.

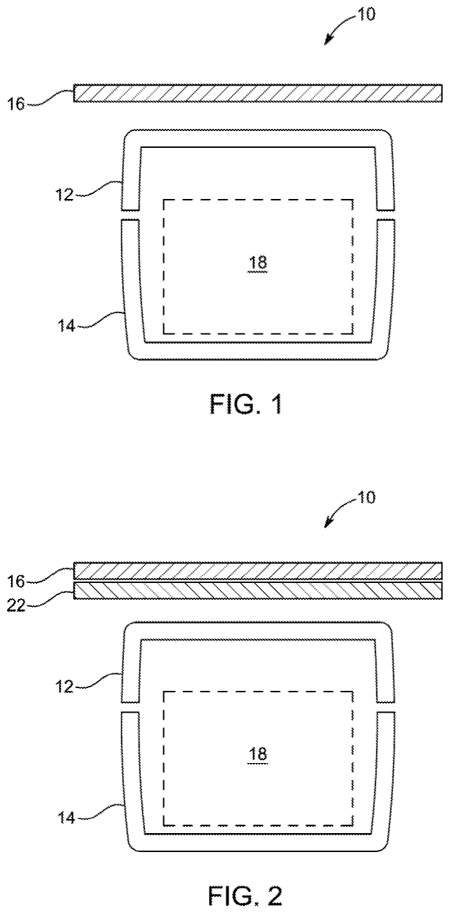

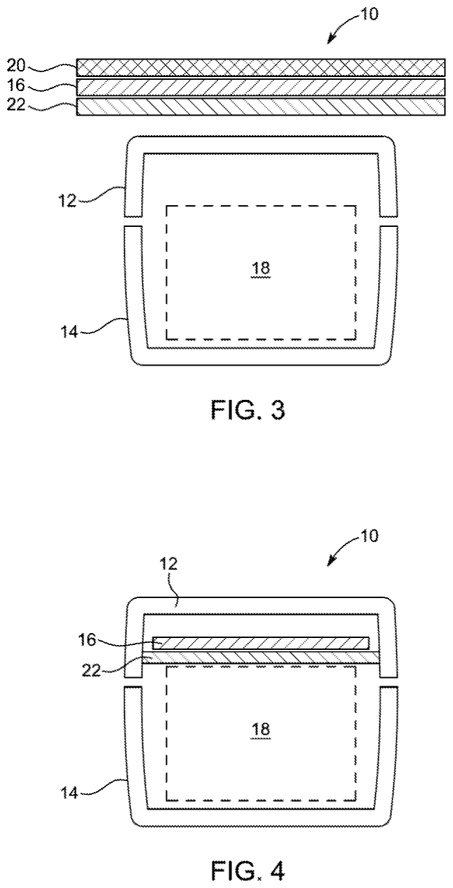

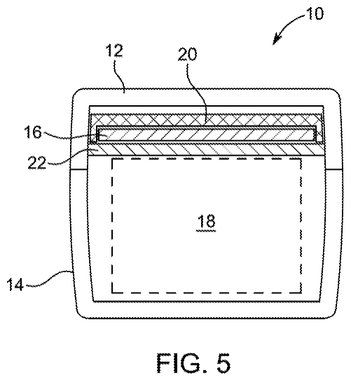

### DETAILED DESCRIPTION OF THE EMBODIMENTS

Embodiments of the present disclosure will now be described more fully hereinafter with reference to the accompanying drawings, in which some, but not all embodiments of the disclosure are shown.

The present disclosure will be better understood with reference to the following definitions. As used herein, the words “a” and “an” and the like carry the meaning of “one or more.” Within the description of this disclosure, where a numerical limit or range is stated, the endpoints are included unless stated otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, “compound” is intended to refer to a chemical entity, whether as a solid, liquid, or gas, and whether in a crude mixture or isolated and purified.

As used herein, “composite” refers to a combination of two or more distinct constituent materials into one. The individual components, on an atomic level, remain separate and distinct within the finished structure. The materials may have different physical or chemical properties, that when combined, produce a material with characteristics different from the original components. In some embodiments, a composite may have at least two constituent materials that comprise the same empirical formula but are distinguished by different densities, crystal phases, or a lack of a crystal phase (i.e. an amorphous phase).

According to a first aspect, the present disclosure relates to a heat resistant structure 10 for a battery. The heat resistant structure 10 comprises an enclosure top 12 and an enclosure bottom 14 configured to enclose a battery 18. The enclosure top 12 is attached to and in direct contact with the enclosure bottom 14, forming an enclosure. The enclosure top 12 and the enclosure bottom 14 comprise a structural composite material.

The heat resistant structure 10 also comprises a heat resistant fiber layer 16 positioned above the enclosure top 12, and this heat resistant fiber layer comprises a heat resistant fiber.

In another embodiment, the heat resistant fiber layer 16 is positioned within the enclosure.

In one embodiment, the heat resistant structure 10 further comprises a support layer top 20 located above the heat resistant fiber layer. In a related embodiment, the heat resistant structure further comprises a support layer bottom 22 located underneath the heat resistant fiber layer 16.

In another related embodiment, the heat resistant structure 10 further comprises both a support layer top 20 and a support layer bottom 22 where the heat resistant fiber layer 16 is sandwiched between the two support layers. In a further embodiment, the heat resistant fiber layer is sealed or encapsulated between these two support layers.

In one embodiment, the heat resistant fiber layer 16 is sandwiched between a support layer top 20 and a support layer bottom 22.

In a further embodiment, the heat resistant fiber layer 16 is encapsulated between the support layer top 20 and the support layer bottom 22.

As used herein, an “enclosure,” as that formed by the enclosure top 12 and enclosure bottom 14 described above, may refer to a structure having a shell or outer case configured to secure or protect at least one battery or cell positioned within an internal volume of the shell or outer case. In certain examples, the battery enclosure may refer to a structure that provides a thermal seal or thermal protection barrier that restricts or reduces the flow of heat from the internal volume of the shell to the volume located outside of the shell (or from outside of the shell to the internal volume of the shell).

Other functions of the enclosure include protecting a battery 18 from external damage, preventing the battery from overheating during nominal operation, protecting the electronic device or vehicle and an end-user of the device from a battery fire or leak, and/or enhancing the performance or extending the life of a battery.

The enclosure may include one or more batteries 18, as mentioned previously. The batten may be any type of battery now known or later developed. In certain examples, the battery is a secondary or rechargeable battery. Non-limiting examples include lead-acid, nickel cadmium, nickel-metal hydride, lithium-ion, lithium-ion polymer, lithium-sulfur, sodium-ion, sodium-sulfur, silver-zinc, zinc-bromide, zinc-cerium, zinc-air, or molten-salt batteries. The batteries described here may be used in vehicles, including but not limited to automobiles, trams, trains, boats, aircraft, and hovercraft. The heat resistant structure described herein may also be adapted to smaller devices comprising batteries, including but not limited to portable electronic devices, cellphones, and medical equipment.

In one embodiment, the enclosure top 12 and the enclosure bottom 14 each independently comprise a polymeric material or a fiber composite material. Nonlimiting examples of polymeric materials include one or more thermoplastic polymer compositions such as acrylics (e.g., poly(methyl methacrylate)), terpolymers (e.g, acrylonitrile butadiene styrene), polyamides (e.g., nylon), aliphatic polyesters (e.g., polylactic acid), polybenzimidazole, polycarbonates, polyether sulfone, polyether ether ketone, polyetherimide, polyethylene, polyethylene oxide, polyethylene terephthalate, polyphenylene oxide, polyphenylene sulfide, polypropylene, polystyrene, polyvinyl chloride, polyvinyl fluoride, or polytetrafluoroethylene, polymethylene oxide, polytetramethylene oxide, polymethylpentene, polymethyl methacrylate, polycaprolactam, polyacrylonitrile, polybutene, polybutadiene, polyvinyl alcohol, polyvinylidene chloride, or polyvinylidene fluoride.

A fiber composite material may comprise a woven fiber layer impregnated with a polymeric material. The polymeric material may be any of those describe above, and the woven fiber layer may comprise glass fibers, carbon fibers, cellulose fibers, aramid fibers, or basalt fibers.

In one embodiment, the enclosure top 12 and the enclosure bottom 14 each independently comprise glass mat-reinforced thermoplastic, polypropylene, polyamide, carbon fiber, or a thermoset material. In one embodiment, the enclosure top and/or the enclosure bottom comprises a structural composite such as GMT® or GMT®, from Mitsubishi Chemical Advanced Materials.

In one embodiment, the enclosure top 12 and enclosure bottom 14 may independently have an average sidewall thickness in a range of 0.1-5 cm, preferably 0.1-4 cm, more preferably 0.2-3 cm, 0.2-2 cm, or 0.3-1 cm. In one embodiment, the enclosure top and enclosure bottom may be removably attached to one another. In another embodiment, the enclosure top and enclosure bottom may be attached together by a heat resistant adhesive.

The enclosure formed by the enclosure top 12 and enclosure bottom 14 may have a length or longest dimension in a range of 10-200 cm, preferably 20-150 cm, more preferably 30-120 cm, a width in a range of 8-150 cm, preferably 10-120 cm, more preferably 12-100 cm, and a height in a range of 5-50 cm, preferably 10-40 cm, more preferably 12-30 cm. In some embodiments, batteries or cells may be placed next to each other but located in separate enclosures. In some embodiments, a single enclosure may comprise more than one battery cell.

In one embodiment, the battery 18 may be sealed within the enclosure, without allowing air to pass. In another embodiment, the enclosure may have one or more vents, allowing air to circulate. In a related embodiment, the enclosure may seal the battery 18 from the outside environment, but may provide one or more vent valves that open under certain temperature and/or pressure conditions. It is envisioned that the one or more vent valves allow a controlled release of pressure and gases in order to delay or prevent an explosion of the enclosure. In one embodiment, the enclosure bottom 14 may be formed in a way to collect leaking electrolyte or battery fluids.

In one embodiment, an air gap may be provided within the enclosure when the enclosure holds a battery 18. The air gap refers to a cavity or air space within the enclosure, which may be advantageous in controlling heat transfer within the battery enclosure via conduction, convection, and/or radiation. The dimensions or size of the air gap are configurable based on the dimensions of the battery or batteries within the enclosure. In some examples, the air gap may be configured to extend lengthwise (as measured along the x-axis) and widthwise (as measured along the y-axis) such that the perimeter of the air gap abuts internal surfaces of the enclosure, a support layer 20/22, or the heat resistant fiber layer 16. The height or thickness (as measured along the z-axis) of the air gap may be 0.01-10 mm, 0.1-1 mm, 0.1-0.5 mm, 0.5-1 mm, or 0.2-0.5 mm. In one embodiment, the enclosure may comprise the heat resistant fiber layer 16 in place of the air gap, where the fiber layer has the similar dimensions and configuration as described above for the air gap.

As mentioned previously, the heat resistant structure 10 comprises a heat resistant fiber layer 16 comprising a heat resistant fiber. In one embodiment, the heat resistant fiber may be a ceramic fiber, a polycrystalline alumina fiber, a polycrystalline aluminosilicate fiber, or a glass fiber. In one embodiment, the heat resistant fiber layer 16 consists essentially of the heat resistant fiber, meaning that the heat resistant fiber layer 16 comprises at least 99 wt %, preferably at least 99.5 wt %, more preferably at least 99.9 wt %, or about 100 wt % heat resistant fiber relative to a total weight of the heat resistant fiber layer.

In one embodiment, the heat resistant fiber comprises 65-80 wt %, preferably 68-78 wt %, more preferably 70-76 wt %, or about 72 wt % alumina and 20-35 wt %, preferably 22-33 wt %, more preferably 24-30 wt %, or about 28 wt % silica, each relative to a total weight of the heat resistant fiber.

In one embodiment, the heat resistant fiber has an average fiber diameter in a range of 4.5-8.5 μm, preferably 4.8-8.3 μm, more preferably 5.0-8.0 μm, even more preferably 6.0-7.5 μm, or about 7 μm. In one embodiment, the heat resistant fiber is woven together to form the heat resistant fiber layer 16. The heat resistant fiber may be woven together by a twill dutch weave, a hex weave, a plain weave, a twill weave, or a basketweave. In another embodiment, the heat resistant fiber may not be woven together but may be felted and tangled to form the fiber layer.

In one embodiment, the heat resistant fiber layer 16 has an average thickness in a ranee of 0.2-4 cm, preferably 0.3-3 cm, more preferably 0.3-2 cm, even more preferably 0.4-2 cm, or 0.4-1 cm, or 0.5-0.8 cm. In one embodiment, the heat resistant fiber layer may have a void volume percentage in a range of 0.1-50 vol %, preferably 0.2-30 vol %, more preferably 0.3-10 vol %.

In one embodiment, the heat resistant structure 10 and/or heat resistant fiber layer 16 is heat resistant to a temperature greater than 800° C., preferably greater than 850° C., more preferably greater than 900° C., more preferably greater than 1,000° C. In a further embodiment, the heat resistant structure 10 and/or heat resistant fiber layer 16 is heat resistant to a temperature in a range of 1,400-1,700° C., preferably 1,450-1,680° C., more preferably 1,500-1,650° C.

In one embodiment, the heat resistant fiber layer 16 may be substantially planar. In other embodiments, the heat resistant fiber layer 16 may have one or more folds or curves, in order to accommodate the shape of a battery or an enclosure for a battery. In one embodiment, the heat resistant fiber layer 16 may wrap around and cover at least 10%, at least 40%, at least 60%, at least 70%, at least 80%, at least 90%, at least 95%, at least 99%, or about all of the external surface of the battery or the battery enclosure. In one embodiment, the heat resistant fiber layer 16 may only cover a top of the battery 18 or enclosure. In another embodiment, the heat resistant fiber layer 16 may cover the top and sides of the battery or enclosure, while leaving the bottom uncovered. In an alternative embodiment, the enclosure top 12 and/or enclosure bottom 14 may comprise the heat resistant fiber layer 16 confined within inner and outer sidewalls. In one embodiment, surfaces outside and away from the battery 18 may also have a heat resistant fiber layer attached, for instance, the entire inner surface of the automobile hood over the battery may have the heat resistant fiber layer. The bottom or sides of a vehicle frame may have the heat resistant fiber layer.

As mentioned previously, the heat resistant fiber layer 16 may be in direct contact with a top and/or bottom support layer 20/22. The support layers may comprise similar materials as mentioned previously for the enclosure top and enclosure bottom, and may have similar thicknesses. The support layer may be used to provide a barrier between the heat resistant fiber layer and the battery. In one embodiment, either support layer comprises a fiber composite such as polypropylene or polyamide reinforced with glass fibers or carbon fibers. In one embodiment, either support layer comprises a fiber composite such as SymaLite® or QTEX®, from Mitsubishi Chemical Advanced Materials. In one embodiment, either support layer may cover a similar area as the heat resistant fiber layer, though in other embodiments, either support layer may cover smaller or larger areas. In one embodiment, multiple layers of heat resistant fiber layer and/or support layers may be combined together.

In some embodiments, the heat resistant fiber layer 16, support layers 20/22, enclosure top 12, and enclosure bottom 14 may be attached to one another or to a frame or internal structure of a vehicle by means of a heat resistant adhesive or a mechanical fastener. The mechanical fastener may be a screw, bolt, clip, staple, clamp, or some other fastener or structure.

The following are exemplary Embodiments of the present disclosure:

Embodiment 1: A heat resistant structure for a battery, comprising:

an enclosure top and an enclosure bottom configured to enclose a battery, the enclosure top attached to and in direct contact with the enclosure bottom; and

a heat resistant fiber layer positioned above the enclosure top,

wherein the enclosure top and the enclosure bottom comprise a structural composite material, and

wherein the heat resistant fiber layer comprises a heat resistant fiber.

Embodiment 2: The heat resistant structure of Embodiment 1, further comprising a support layer top located above the heat resistant fiber layer.

Embodiment 3: The heat resistant structure of Embodiment 1 or 2, wherein the heat resistant fiber layer is sandwiched between a support layer top and a support layer bottom.

Embodiment 4: The heat resistant structure of any one of Embodiments 1 to 3, wherein the heat resistant fiber layer is encapsulated between the support layer top and the support layer bottom.

Embodiment 5: The heat resistant structure of any one of Embodiments 1 to 4, wherein the heat resistant fiber layer encircles a top and sides of the battery enclosure top and a bottom and sides of the battery enclosure bottom.

Embodiment 6: The heat resistant structure of any one of Embodiments 1 to 5, wherein the heat resistant fiber comprises a ceramic fiber, a polycrystalline alumina fiber, or a glass fiber.

Embodiment 7: The heat resistant structure of any one of Embodiments 1 to 6, wherein the heat resistant fiber comprises 65-80 wt % alumina and 20-35 wt % silica, each relative to a total weight of the heat resistant fiber.

Embodiment 8: The heat resistant structure of any one of Embodiments 1 to 7, wherein the heat resistant fiber layer consists essentially of the heat resistant fiber.

Embodiment 9: The heat resistant structure of any one of Embodiments 1 to 8, wherein the heat resistant fiber has an average fiber diameter in a range of 4.5-8.5 μm.

Embodiment 10: The heat resistant structure of any one of Embodiments 1 to 9, wherein the heat resistant fiber layer has an average thickness in a range of 0.2-4 cm.

Embodiment 11: The heat resistant structure of any one of Embodiments 1 to 10, wherein the enclosure top and the enclosure bottom each independently comprise a polymeric material or a fiber composite material.

Embodiment 12: The heat resistant structure of any one of Embodiments 1 to 11, wherein the enclosure top and the enclosure bottom each independently comprise glass mat thermoplastic, polypropylene, polyamide, carbon fiber, thermoset material.

Embodiment 13: The heat resistant structure of any one of Embodiments 1 to 12, wherein the heat resistant fiber is woven together by a twill dutch weave, a hex weave, a plain weave, a twill weave, or a basketweave.

Embodiment 14: The heat resistant structure of any one of Embodiments 1 to 13, further comprising a support layer bottom located between the heat resistant fiber layer and the enclosure top.

Embodiment 15: The heat resistant structure of any one of Embodiments 1 to 14, wherein the heat resistant fiber layer is heat resistant to a temperature greater than 800° C.

Embodiment 16: The heat resistant structure of any one of Embodiments 1 to 15, wherein the heat resistant fiber layer is heat resistant to a temperature in a range of 1,400-1,700° C.

Embodiment 17: The heat resistant structure of any one of Embodiments 1 to 16, further comprising a fire-resistant adhesive.

Embodiment 18: The heat resistant structure of any one of Embodiments 1 to 17, wherein the enclosure top or the enclosure bottom comprises a vent valve.

Embodiment 19: A heat resistant structure for a battery, comprising:

an enclosure top and an enclosure bottom configured to enclose a battery, the enclosure top attached to and in direct contact with the enclosure bottom;

a heat resistant fiber layer positioned between and enclosed by the enclosure top and the enclosure bottom.

Embodiment 20: The heat resistant structure of Embodiment 19, further comprising a support layer bottom underneath and in direct contact with the heat resistant layer, the support layer bottom configured to be positioned above the battery.

Embodiment 21: The heat resistant structure of Embodiment 19 or 20, further comprising a support layer top positioned between the enclosure top and the heat resistant layer.

Embodiment 22: The heat resistant structure of any one of Embodiments 19 to 21, wherein the heat resistant layer is encapsulated within the support layer top and the support layer bottom.

Embodiment 23: The heat resistant structure of any one of Embodiments 19 to 22, wherein the heat resistant fiber layer encircles the top, bottom, and sides of the battery.

Embodiment 24: The heat resistant structure of any one of Embodiments 19 to 23, wherein the heat resistant fiber comprises a ceramic fiber, a polycrystalline alumina fiber, or a glass fiber.

Embodiment 25: The heat resistant structure of any one of Embodiments 19 to 24, wherein the heat resistant fiber comprises 65-80 wt % alumina and 20-35 wt % silica, each relative to a total weight of the heat resistant fiber.

Embodiment 26: The heat resistant structure of any one of Embodiments 19 to 25, wherein the heat resistant fiber layer consists essentially of the heat resistant fiber.

Embodiment 27: The heat resistant structure of any one of Embodiments 19 to 26, wherein the heat resistant fiber has an average fiber diameter in a range of 4.5-8.5 μm.

Embodiment 28: The heat resistant structure of any one of Embodiments 19 to 27, wherein the heat resistant fiber layer has an average thickness in a range of 0.2-4 cm.

Embodiment 29: The heat resistant structure of any one of Embodiments 19 to 28, wherein the enclosure top and the enclosure bottom each independently comprise a polymeric material or a fiber composite material.

Embodiment 30: The heat resistant structure of any one of Embodiments 19 to 29, wherein the enclosure top and the enclosure bottom each independently comprise glass mat thermoplastic, polypropylene, polyamide, carbon fiber, thermoset material.

Embodiment 31: The heat resistant structure of any one of Embodiments 19 to 30, wherein the heat resistant fiber is woven together by a twill dutch weave, a hex weave, a plain weave, a twill weave, or a basketweave.

Embodiment 32: The heat resistant structure of any one of Embodiments 19 to 31, further comprising a support layer bottom located between the heat resistant fiber layer and the enclosure top.

Embodiment 33: The heat resistant structure of any one of Embodiments 19 to 32, wherein the heat resistant fiber layer is heat resistant to a temperature greater than 800° C.

Embodiment 34: The heat resistant structure of any one of Embodiments 19 to 33, wherein the heat resistant fiber layer is heat resistant to a temperature in a range of 1,400-1,700° C.

Embodiment 35: The heat resistant structure of any one of Embodiments 19 to 34, further comprising a fire-resistant adhesive.

Embodiment 36: The heat resistant structure of any one of Embodiments 19 to 35, wherein the enclosure top or the enclosure bottom comprises a vent valve.

1: A heat resistant structure for a battery, comprising:
an enclosure top and an enclosure bottom configured to enclose a battery, the enclosure top attached to and in direct contact with the enclosure bottom; and
a heat resistant fiber layer positioned above the enclosure top,
wherein the enclosure top and the enclosure bottom comprise a structural composite material, and
wherein the heat resistant fiber layer comprises a heat resistant fiber.

2: The heat resistant structure of claim 1, further comprising a support layer top located above the heat resistant fiber layer.

3: The heat resistant structure of claim 1, wherein the heat resistant fiber layer is sandwiched between a support layer top and a support layer bottom.

4: The heat resistant structure of claim 3, wherein the heat resistant fiber layer is encapsulated between the support layer top and the support layer bottom.

5: The heat resistant structure of claim 1, wherein the heat resistant fiber layer encircles a top and sides of the battery enclosure top and a bottom and sides of the battery enclosure bottom.

6: The heat resistant structure of claim 1, wherein the heat resistant fiber comprises a ceramic fiber, a polycrystalline alumina fiber, or a glass fiber.

7: The heat resistant structure of claim 1, wherein the heat resistant fiber comprises 65-80 wt % alumina and 20-35 wt % silica, each relative to a total weight of the heat resistant fiber.

8: The heat resistant structure of claim 1, wherein the heat resistant fiber layer consists essentially of the heat resistant fiber.

9: The heat resistant structure of claim 8, wherein the heat resistant fiber has an average fiber diameter in a range of 4.5-8.5 μm.

10: The heat resistant structure of claim 1, wherein the heat resistant fiber layer has an average thickness in a range of 0.2-4 cm.

11: The heat resistant structure of claim 1, wherein the enclosure top and the enclosure bottom each independently comprise a polymeric material or a fiber composite material.

12: The heat resistant structure of claim 1, wherein the enclosure top and the enclosure bottom each independently comprise glass mat thermoplastic, polypropylene, polyamide, carbon fiber, thermoset material.

13: The heat resistant structure of claim 1, wherein the heat resistant fiber is woven together by a twill dutch weave, a hex weave, a plain weave, a twill weave, or a basketweave.

14: The heat resistant structure of claim 1, further comprising a support layer bottom located between the heat resistant fiber layer and the enclosure top.

15: The heat resistant structure of claim 1, wherein the heat resistant fiber layer is heat resistant to a temperature greater than 800° C.

16: The heat resistant structure of claim 1, wherein the heat resistant fiber layer is heat resistant to a temperature in a range of 1,400-1,700° C.

17: The heat resistant structure of claim 1, further comprising a fire-resistant adhesive.

18: The heat resistant structure of claim 1, wherein the enclosure top or the enclosure bottom comprises a vent valve.

19: A heat resistant structure for a battery, comprising:
an enclosure top and an enclosure bottom configured to enclose a battery, the enclosure top attached to and in direct contact with the enclosure bottom;
a heat resistant fiber layer positioned between and enclosed by the enclosure top and the enclosure bottom.

20: The heat resistant structure of claim 19, further comprising a support layer bottom underneath and in direct contact with the heat resistant layer, the support layer bottom configured to be positioned above the battery.

21: The heat resistant structure of claim 20, further comprising a support layer top positioned between the enclosure top and the heat resistant layer.

22: The heat resistant structure of claim 21, wherein the heat resistant layer is encapsulated within the support layer top and the support layer bottom.

23: The heat resistant structure of claim 22, wherein the heat resistant fiber layer is configured to encircle the top, bottom, and sides of the battery.
